(19) United States
(12) Patent Application Publication
(10) Pub. No.: US 2021/0006648 A1
(43) Pub. Date: Jan. 7, 2021

(54) ELECTRICAL CONNECTION DEVICE AND ELECTRONIC DEVICE COMPRISING SAME

(71) Applicant: Samsung Electronics Co., Ltd., Suwon-si (KR)

(72) Inventors: Jaeryong HAN, Suwon-si (KR); Heekang YUN, Suwon-si (KR); Kwangmin GIL, Suwon-si (KR); Changmin LEE, Suwon-si (KR)

(21) Appl. No.: 16/976,575

(22) PCT Filed: Feb. 26, 2019
(86) PCT No.: PCT/KR2019/002254

§ 371 Date: Aug. 28, 2020

(30) Foreign Application Priority Data
Feb. 28, 2018 (KR) 10-2018-0024719

(51) Int. Cl. H04M 1/02; H01Q 1/24; H01R 9/05; H01R 12/71

(52) U.S. Cl. CPC H04M 1/0277; H01Q 1/243; H01R 12/716; H01R 9/05; H04M 1/0274

(57) ABSTRACT

According to various embodiments, an electronic device can comprise: a housing; a printed circuit board (PCB) arranged inside the housing; a receptacle mounted on the PCB and comprising a base structure, which includes a first surface facing the direction opposite to the PCB and a second surface facing the direction opposite to the first surface and mounted on the PCB, a first conductive ring-shaped side wall, which protrudes from the first surface of the base structure, forms a recess together with the first surface, and has a first diameter, and a conductive pillar structure, which protrudes from the first surface, is arranged at least partially in the recess, and is encompassed in a lateral direction by the first conductive ring-shaped side wall; a connector separably coupled to the receptacle and comprising an upper structure, which includes a third surface facing the direction opposite to the receptacle and a fourth surface facing the receptacle, a second conductive ring-shaped side wall, which is coupled to the first conductive rein-shaped side wall, protrudes from the fourth surface, and has a second diameter that is smaller than the first diameter, and a conductive protrusion, which protrudes from the fourth surface and forms a recess structure arranged in a direction such that at least a portion of the conductive pillar structure is accommodated; and a cable, which is a coaxial cable including an end portion connected to the connector and includes a first conductive path connected to the conductive protrusion and a second conductive path connected to the second conductive ring-shaped side wall. Other various embodiments can be possible.

### CROSS-REFERENCE TO RELATED APPLICATIONS

This application is a 371 of International Application No. PCT/KR2019/002254 filed on Feb. 26, 2019, which claims priority to Korean Patent Application No. 10-2018-0024719 filed on Feb. 28, 2018, the disclosures of which are herein incorporated by reference in their entirety.

### BACKGROUND

### 1. Field

Various embodiments of disclosure relate to an electrical connection device and an electronic device including same.

### 2. Description of Related Art

Electronic devices may include a plurality of electronic function groups. Electronic parts of electronic devices may be spaced predetermined gaps apart from each other in the electronic devices. Such spaced arrangement may be based on the design structures of the parts in the electronic devices or may be based prevention of performance of parts due to noise generated by other parts.

In order to electrically connect at least two electronic parts, there is a need for a specific electrical connection device and the electrical connection device should have an electrical connection structure having excellent durability and reliability even against long-term use of an electronic device and external shock.

An electronic device may have a configuration in which electronic parts spaced apart from each other are electrically connected to each other to achieve various functions. In this case, a first electronic part and a second electronic part may be electrically connected by an electrical connection device. For example, an electrical connection device may include a cable having a predetermined length, and a connector installed at an end of the cable is physically brought in contact with a receptacle disposed in a counter-electronic part, whereby the two electronic parts can be electrically connected.

The electrical connection device may be advantageous when a first electronic part and a second electronic part are assembled in a separate state in terms of the manufacturing process, and may be advantageous in terms of maintenance. However, even though the electronic connection device is used for a long period of time, connection force should be continuously maintained and plastic deformation due to external shock or load should not be generated.

According to various embodiments of the disclosure, it is possible to provide an electrical connection device and an electronic device including the electrical connection device.

According to various embodiments of the disclosure, it is possible to provide an electrical connection device that can be more conveniently assembled, and an electronic device including the electrical connection device.

### SUMMARY

According to various embodiments, an electronic device includes: a housing: a printed circuit board disposed in the housing; a receptacle mounted on the printed circuit board, the receptacle having a base structure that has a first surface opposite to the printed circuit board and a second surface opposite to the first surface and mounted on the printed circuit board, a first conductive ring-shaped side wall that protrudes from the first surface of the base structure, forms a recess together with the first surface, and has a first diameter, and a conductive pillar structure that protrudes from the first surface, is at least partially disposed in the recess, and is laterally surrounded by the first conductive ring-shaped side wall; a connector separably coupled to the receptacle and having an upper structure that has a third surface opposite to the receptacle and a fourth surface facing the receptacle, a second conductive ring-shaped side wall that is configured to be coupled to the first conductive ring-shaped side wall, protrudes from the fourth surface, and has a second diameter smaller than the first diameter, and a conductive protrusion that forms a recess structure headed and disposed to accommodate at least a portion of the conductive pillar structure and protrudes from the fourth surface; and a cable being as a coaxial cable that has an end connected to the connector, and having a first conductive path connected to the conductive protrusion and a second conductive path connected to the second conductive ring-shaped side wall.

According to various embodiments, a receptacle that is coupled to a connector includes: a base structure having a first surface and a second surface opposite to the first surface and mounted on a printed circuit board; a first conductive ring-shaped side wall protruding from the first surface of the base structure, forming a recess together with the first surface, and having a first diameter; and a conductive pillar structure protruding from the first surface, at least partially disposed in the recess, and laterally surrounded by the first conductive ring-shaped side wall—in which the first diameter of the first conductive ring-shaped side wall has a size allowing a second conductive ring-shaped side wall of the connector to be accommodated in the recess.

According to various embodiments, a connector that is coupled to a receptacle includes: an upper structure having a first surface opposite to the receptacle and a second surface facing the receptacle; a first conductive ring-shaped side wall protruding from the second surface and having a first diameter to be coupled to a second conductive ring-shaped side wall of the receptacle; and a conductive protrusion at least partially disposed in a space defined by the first conductive ring-shaped side wall, and protruding from the second surface, in which the first diameter of the first conductive ring-shaped side wall may have a size allowing the second conductive ring-shaped side wall to be accommodated in a recess formed by the second conductive ring-shaped side wall of the receptacle.

According to various embodiments, the assembly structure of a connector and a receptacle is improved, whereby it is possible to prevent damage in assembling and secure reliability in assembling.

### BRIEF DESCRIPTION OF THE DRAWINGS

FIG. 1 is a front perspective view of a mobile electronic device according to various embodiments of the disclosure;

FIG. 2 is a rear perspective view of the electronic device of FIG. 1 according to various embodiments of the disclosure;

FIG. 3 is an exploded perspective view of the electronic device of FIG. 1 according to various embodiments of the disclosure;

FIG. 4 is a view showing the configuration of the electronic device equipped with an electrical connection device according to various embodiments of the disclosure;

FIG. 5 is an exploded perspective view of the electrical connection device according to various embodiments of the disclosure;

FIG. 6A is a cross-sectional view taken along line A-A′ of a receptacle of FIG. 5 according to various embodiments of the disclosure;

FIG. 6B is a cross-sectional view taken along line B-B′ of a connector of FIG. 5 according to various embodiments of the disclosure;

FIG. 7 is a cross-sectional view showing the state in which the receptacle and the connector of FIG. 5 according to various embodiments of the disclosure are combined;

FIG. 8 is a plan view showing the state in which the connector according to various embodiments of the disclosure is electrically connected to the receptacle;

FIG. 9 is a perspective view showing a conductive protrusion according to various embodiments of the disclosure;

FIG. 10 is a perspective view showing the state in which a connector is mounted on an FPCB according to various embodiments of the disclosure;

FIG. 11 is an exploded perspective view of the electrical connection device according to various embodiments of the disclosure;

FIG. 12A is a cross-sectional view taken along line A-A′ of a receptacle of FIG. 5 according to various embodiments of the disclosure;

FIG. 12B is a cross-sectional view taken along line B-B′ of a connector of FIG. 5 according to various embodiments of the disclosure; and

FIG. 13 is a cross-sectional view showing the state in which the receptacle and the connector of FIG. 5 according to various embodiments of the disclosure are combined.

### DETAILED DESCRIPTION

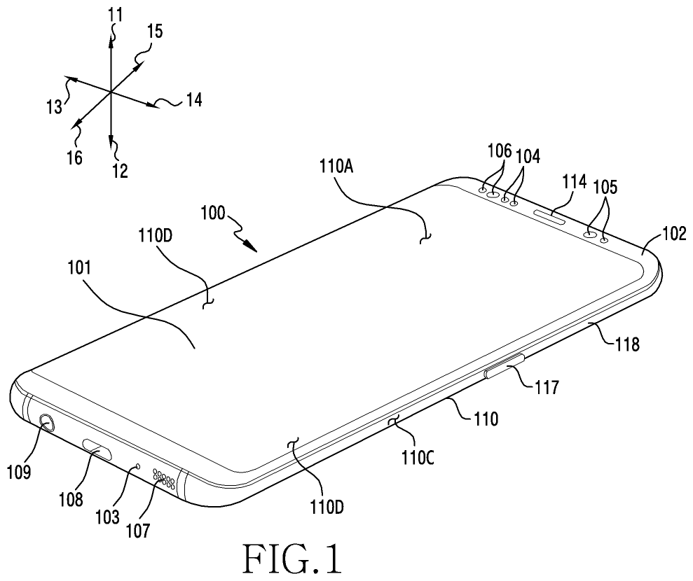

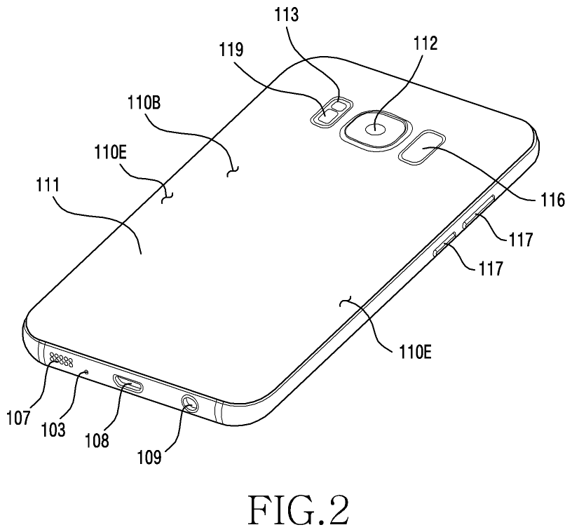

FIG. 1 is a front perspective view of a mobile electronic device according to various embodiments of the disclosure. FIG. 2 is a rear perspective view of the electronic device of FIG. 1 according to various embodiments of the disclosure.

Referring to FIGS. 1 and 2, the mobile electronic device 100 according to an embodiment may include a housing 110 including a first surface (or a front surface) 110A, a second surface (or a rear surface) 110B, and a side surface 100C surrounding a space between the first surface 110A and the second surface 110B. In another embodiment (not shown), the housing may refer to a structure which forms a part of the first surface 110A, the second surface 110B, and the side surface 110C. According to an embodiment, the first surface 110A may be formed by a front surface plate 102 having at least a portion substantially transparent (for example, a glass plate including various coating layers, or a polymer plate). The second surface 110B may be formed by a substantially opaque rear surface plate 111. The rear surface plate 111 may be formed by coated or colored glass, ceramic, polymer, metal (for example, aluminum, stainless steel (STS), or magnesium), or a combination of at least two of the above-mentioned materials. The side surface 110C may be formed by a side surface bezel structure (or a side surface member) 118 which is coupled with the front surface plate 102 and the rear surface plate 111, and includes metal and/or polymer. In a certain embodiment, the rear surface plate 111 and the side surface bezel structure 118 may be integrally formed with each other, and may include the same material (for example, a metallic material such as aluminum).

In the illustrated embodiment, the front surface plate 102 may include two first regions 110D which are bent from the first surface 110A toward the rear surface plate 111 and are extended seamlessly on both ends of long edges of the front surface plate 102. In the illustrated embodiment (see FIG. 2), the rear surface plate 111 may include two second regions 110E which are bent from the second surface 110B toward the front surface plate 102 and are extended seamlessly on both ends of long edges. In a certain embodiment, the front surface plate 102 (or the rear surface plate 111) may include only one of the first regions 110D (or the second regions 110E). In another embodiment, a portion of the first regions 110E or the second regions 110E may not be included. In the embodiments, when viewed from the side of the electronic device 100, the side surface bezel structure 118 may have a first thickness (width) on a side surface that does not include the first regions 110D or the second regions 110E, and may have a second thickness which is thinner than the first thickness on a side surface that includes the first regions 110D or the second regions 110E.

According to an embodiment, the electronic device 100 may include at least one of a display 101, an audio module 103, 107, 114, a sensor module 104, 116, 119, a camera module 105, 112, 113, a key input device 117, a light emitting element 106, and a connector hole 108, 109. In a certain embodiment, the electronic device 100 may omit at least one of the elements (for example, the key input device 117, or the light emitting element 106), or may further include other elements.

The display 101 may be exposed through a corresponding portion of the front surface plate 101, for example. In a certain embodiment, at least a portion of the display 101 may be exposed through the front surface plate 102 which forms the first surface 110A and the first regions 110D of the side surface 110C. In a certain embodiment, a corner of the display 101 may be formed substantially the same as shapes of adjacent outer portions of the front surface plate 102. In another embodiment (not shown), a distance between an outer portion of the display 101 and the outer portion of the front surface plate 102 may be formed to be substantially the same as in order to expand an exposed area of the display 101.

In another embodiment (not shown), a recess or an opening may be formed on a portion of a screen display region of the display 101, and the electronic device 100 may include at least one of the audio module 114, the sensor module 104, the camera module 105, and the light emitting element 106 which are aligned with the recess or opening. In another embodiment (not shown), the electronic device 100 may include, on a rear surface of the screen display region of the display 101, at least one of the audio module 114, the sensor module 104, the camera module 105, the fingerprint sensor 116, and the light emitting element 106. In another embodiment (not shown), the display 101 may be coupled with or disposed adjacent to a touch sensing circuit, a pressure sensor for measuring an intensity of a touch (pressure), and/or a digitizer for detecting a stylus pen in a magnetic field method. In a certain embodiment, at least a part of the sensor module 104, 119, and/or at least a part of the key input device 117 may be disposed on the first regions 110D and/or the second regions 110E.

The audio module 103, 107, 114 may include a microphone hole 103 and a speaker hole 107, 114. The microphone hole 103 may have a microphone disposed therein to obtain an external sound, and in a certain embodiment, a plurality of microphones may be disposed to detect a direction of a sound. The speaker hole 107, 114 may include an external speaker hole 107 and a call receiver hole 114. In a certain embodiment, the speaker hole 107, 114 and the microphone hole 104 may be implemented as one hole or the electronic device 100 may include a speaker without the speaker hole 107, 114.

The sensor module 104, 116, 119 may generate an electric signal or a data value corresponding to an operation state of the inside of the electronic device 100, or an external environment state. The sensor module 104, 116, 119 may include, for example, a first sensor module 104 (for example, a proximity sensor) and/or a second sensor module (not shown) (for example, a fingerprint sensor) which is disposed on the first surface 110A of the housing 110, and/or a third sensor module 119 (for example, an HRM sensor) and/or a fourth sensor module 116 (for example, a fingerprint sensor) which is disposed on the second surface 110B of the housing 110. The fingerprint sensor may be displayed not only on the first surface 110A (for example, the display 101) of the housing 110 but also on the second surface 110B. The electronic device 100 may further include a sensor module which is not shown, for example, at least one of a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor 104.

The camera module 105, 112, 113 may include a first camera device 105 which is disposed on the first surface 110A of the electronic device 100, and a second camera device 112 and/or a flash 113 which is disposed on the second surface 110B. The camera devices 105, 112 may include one or more lenses, an image sensor, and/or an image signal processor. The flash 113 may include, for example, a light emitting diode or a xenon lamp. In a certain embodiment, two or more lenses (an IR camera, a wide angle and telephoto lens), and image sensors may be disposed on one surface of the electronic device 100.

The key input device 117 may be disposed on the side surface 100C of the housing 110. In another embodiment, the electronic device 100 may not include a portion or an entirety of the above-mentioned key input device 117, and the key input device 117 that is not included may be implemented on the display 101 in other forms such as a soft key or the like. In a certain embodiment, the key input device may include the sensor module 116 disposed on the second surface 110B.

The light emitting element 106 may be disposed on, for example, the first surface 110A of the housing 110. The light emitting element 106 may provide state information of the electronic device 100 in the form of light, for example. In another embodiment, the light emitting element 106 may provide a light source which is associated with an operation of the camera module 105. The light emitting element 106 may include, for example, a light emitting diode (LED), an IR LED, and a xenon lamp.

The connector hole 108, 109 may include a first connector hole 108 to receive a connector (for example, a USB connector) for transmitting and receiving power and/or data to and from an external electronic device, and/or a second connector hole (for example, an earphone jack) 109 to receive a connector for transmitting and receiving an audio signal to and from an external electronic device.

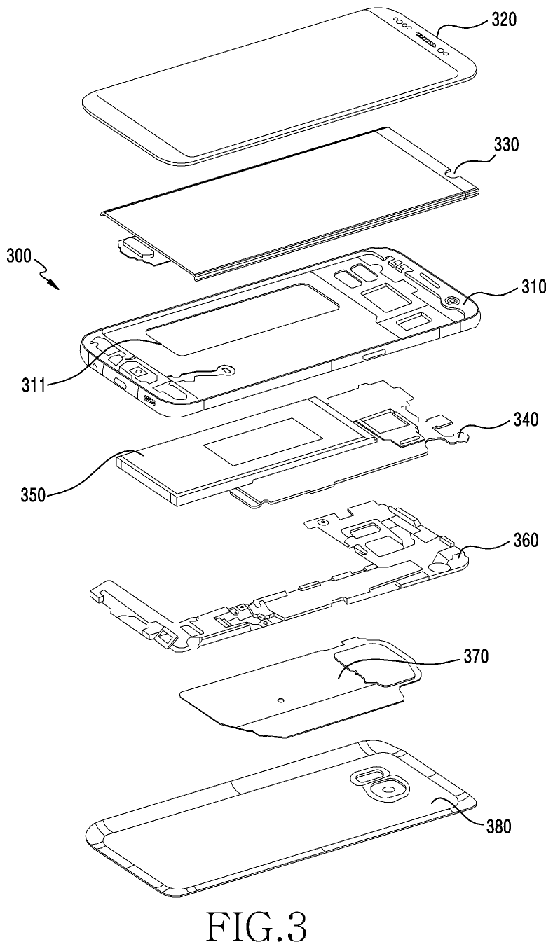

FIG. 3 is an exploded perspective view of the mobile electronic device (e.g., mobile electronic device 100 of FIG. 1) according to various embodiments of the disclosure.

Referring to FIG. 3, the mobile electronic device 300 may include a side surface bezel structure 310, a first support member 311 (for example, a bracket), a front surface plate 320, a display 330, a printed circuit board 340, a battery 350, a second support member 360 (for example, a rear case), an antenna 370, and a rear surface plate 380. In a certain embodiment, the electronic device 300 may omit at least one of the elements (for example, the first support member 311, or the second support member 360), or may further include other elements. At least one of the elements of the electronic device 300 may be the same as or similar to at least one of the elements of the electronic device 100 of FIG. 1 or 2, and a redundant explanation is omitted.

The first support member 311 may be disposed inside the electronic device 300, and may be connected with the side surface bezel structure 310 or may be integrally formed with the side surface bezel structure 310. The first support member 311 may be formed with, for example, a metallic material and/or a non-metallic material (for example, polymer). The first support member 311 may have one surface to which the display 330 is coupled, and the other surface to which the printed circuit board 340 is coupled. The printed circuit board 340 may have a processor, a memory, and/or an interface mounted therein. The processor may include, for example, one or more of a central processing unit, an application processor, a graphic processing unit, an image signal processor, a sensor hub processor, or a communication processor.

The memory may include, for example, a volatile memory or a non-volatile memory.

The interface may include, for example, a high definition multimedia interface (HDMI), a universal serial bus (USB) interface, an SD card interface, and/or an audio interface. The interface may electrically or physically connect the electronic device 300 to an external electronic device, and may include a USB connector, an SD card/MMC connector, or an audio connector.

The battery 350 may be a device which supplies power to at least one element of the electronic device 300, and may include, for example, a primary battery which is not rechargeable, or a rechargeable secondary battery, or a fuel battery. At least a portion of the battery 350 may be disposed substantially on the same plane as the printed circuit board 340. The battery 350 may be integrally disposed inside the electronic device 300, or may be disposed to be attachable to and detachable from the electronic device 300.

The antenna 370 may be disposed between the rear surface plate 380 and the battery 350. The antenna 370 may include, for example, a near field communication (NFC) antenna, a wireless charging antenna, and/or a magnetic secure transmission (MST) antenna. The antenna 370 may perform short range communication with an external device, or may wirelessly transmit and receive power necessary for charging. In another embodiment, an antenna structure may be formed by a part or a combination of the side surface bezel structure 310 and/or the first support member 311.

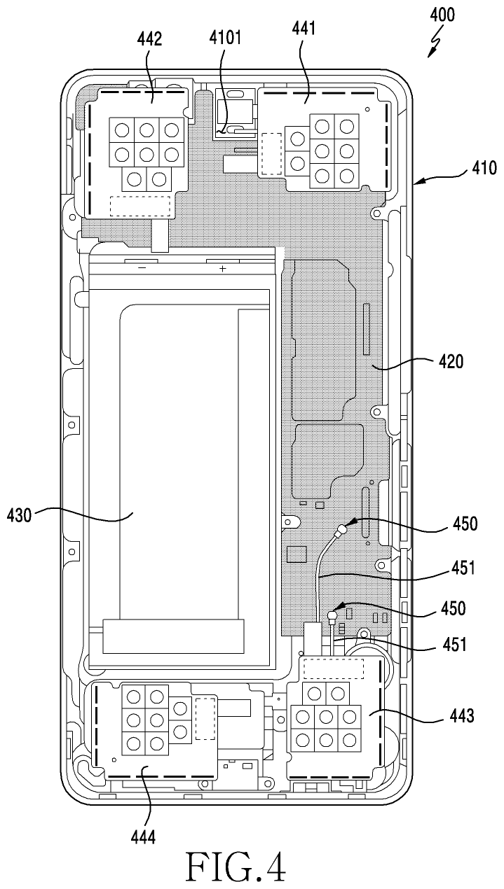

FIG. 4 is a view showing the configuration of the electronic device 400 equipped with an electrical connection device 450 according to various embodiments of the disclosure.

The electronic device 400 show in FIG. 4 may be at least partially similar to the electronic device 100 shown in FIGS. 1 and 2 or the electronic device 300 shown in FIG. 3, or may include other embodiments of electronic devices.

Referring to FIG. 4, the electronic device 400 may include a plurality of electronic parts disposed in an internal space 4101 defined by a side bezel 410. According to an embodiment, the electronic parts may include a printed circuit board 420, a first communication device 441, a second communication device 442, a third communication device 443, a fourth communication device 444, or a battery 430. According to an embodiment, printed circuit board 420 may be disposed to avoid or at least partially overlap the battery or the communication devices 441, 442, 443, and 444.

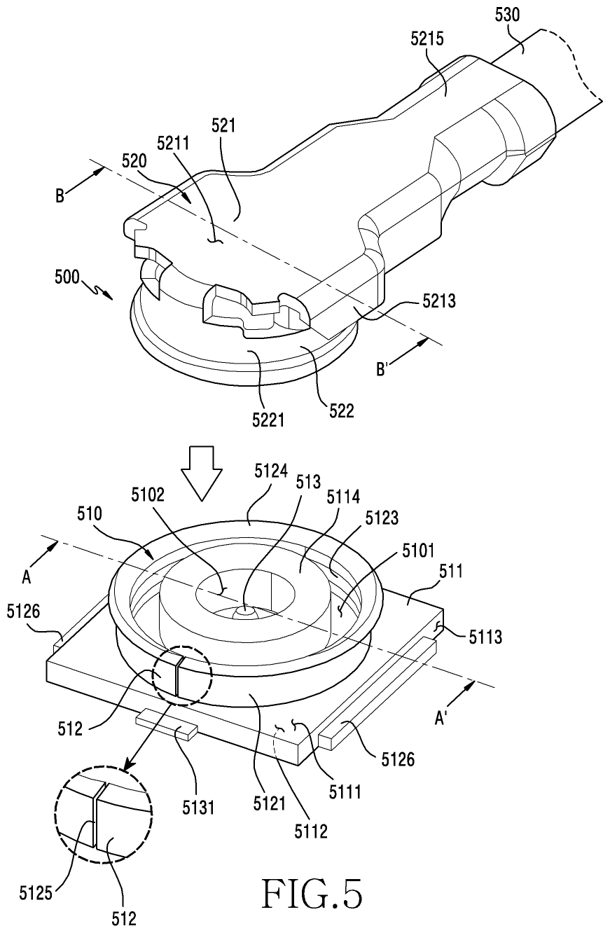

According to various embodiments the electronic device 400 may include a conductive cable 451 electrically connecting the printed circuit board 420 to the third communication device 443 spaced apart from the printed circuit board 420. According to another embodiment, a conductive cable 451 for electrical connection in the printed circuit board 420 may be used. According to an embodiment, the conductive cable 451 may include a coaxial cable for reducing a loss of an RF signal and securing performance of the third communication device 443. However, the conductive cable 451 is not limited thereto and may include a Flexible Printed Circuit Board (FPCB). According to an embodiment, the electronic device 400 may include an electrical connection device 450 disposed at the joint of the conductive cable 451 and the printed circuit board 420 to electrically connect the printed circuit board 420 and the communication device 443 to each other. According to an embodiment, the electrical connection device 450 may include a receptacle (e.g., the receptacle 510 shown in FIG. 5) disposed in the printed circuit board 420 and the communication device 443, and a connector (e.g., the connector 520 shown in FIG. 5) electrically connected to the end of the conductive cable 451 and separably coupled to the receptacle (e.g., the receptacle 510 shown in FIG. 5). According to an embodiment, at least a portion of the receptacle and the connector is made of a conductive material and may be coupled by a worker when the electronic device is assembled.

According to various embodiments, the connector (e.g., the connector 520 shown in FIG. 5) of the electrical connection device 450 may have a coupling structure that can prevent mis-insertion or incomplete insertion and can naturally induce coupling when it is coupled to the receptacle (e.g., the receptacle 510 shown in FIG. 5) of the printed circuit board 420. According to an embodiment, the electrical connection device 450 may be formed in a shape and structure that the coupling position of the receptacle is visually recognized when a worker couples the connector to the receptacle.

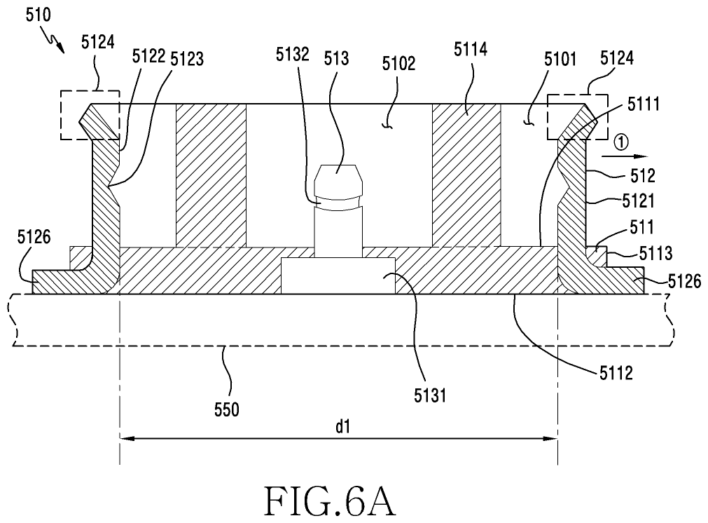

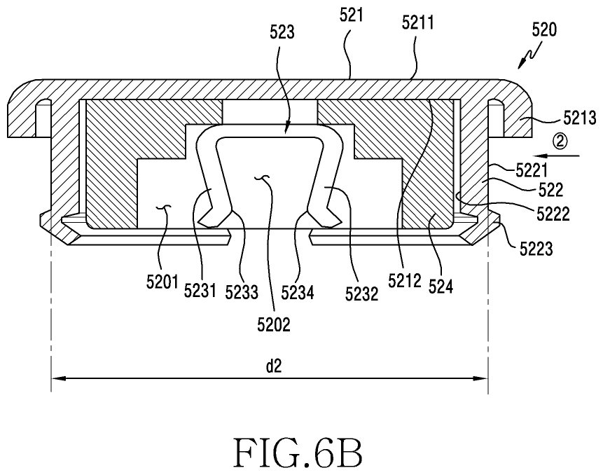

FIG. 5 is an exploded perspective view of the electrical connection device 500 according to various embodiments of the disclosure. FIG. 6A is a cross-sectional view taken along line A-A′ of the receptacle 510 of FIG. 5 according to various embodiments of the disclosure. FIG. 6B is a cross-sectional view taken along line B-B′ of the connector 520 of FIG. 5 according to various embodiments of the disclosure.

The electrical connection device 500 shown in FIG. 5 may be at least partially similar to the electrical connection device 450 shown in FIG. 4 or may include other embodiments of electrical connection devices.

Referring to FIGS. 5 to 6B, the electrical connection device 500 may include a receptacle 510 mounted on a first electronic part (e.g., a printed circuit board 550) and a connector 520 installed at an end of a conductive cable 530 and separably coupled to the receptacle 510. According to an embodiment, another end of the conductive cable 530 may be electrically connected to a second electronic part (e.g., a communication device) through another electrical connection device 500 having the same configuration as the electronic connection device 500.

According to various embodiments, the receptacle 510 may include a base structure 511 having a first surface 5111, a second surface 5112 opposite to the first surface 5111 and mounted on the printed circuit board 550, and a side 5113 surrounding the portion between the first surface 5111 and the second surface 5112; a first conductive ring-shaped side wall 512 protruding from the first surface 5111 of the base structure 511, forming a recess 5101 together with the first surface 5111, and having a first diameter d1 (e.g., an inner diameter); and a conductive pillar structure 513 protruding from the first conductive ring-shaped side wall 512 and the first surface 5111, at least partially disposed in the recess 5102, and laterally surrounded by the first conductive ring-shaped side wall 512. According to an embodiment, the first conductive ring-shaped side wall 512 may be formed in a cylindrical shape. As another example, the first conductive ring-shaped side wall 512 may be formed in various shapes (e.g., a rectangle, an ellipse, or a polygon) corresponding to the shape of a second conductive ring-shaped side wall 522 of the connector 520 that can be accommodated in the recess 5101.

According to various embodiments, the base structure 511 may be made of an insulating material and may be disposed to electrically disconnect the first conductive ring-shaped side wall 512 and the conductive pillar structure 513. According to an embodiment, the conductive pillar structure 513 may protrude upward from the first surface 5111 substantially at the center of the recess 5101 of the first conductive ring-shaped side wall 512. According to an embodiment, the conductive pillar structure 513 may have a locking groove 5132 formed on the outer surface thereof. According to an embodiment, the conductive pillar structure 513 may be at least partially disposed on the base structure 511 by insert injection. According to an embodiment, the base structure 511 may have a protrusion 5114 that has a smaller diameter than the first conductive ring-shaped side wall 512 coaxially with the conductive pillar structure 513 and protrudes upward. According to an embodiment, the conductive pillar structure 513 may be disposed in the center area of a space 5102 defined by the protrusion 5114. As another example, the protrusion 5114 may not be provided in the base structure 511.

According to an embodiment, the first conductive ring-shaped side wall 512 may have an outer surface 5121 and an inner surface 5122 that extend a predetermined length. According to an embodiment, the first conductive ring-shaped side wall 512 may have a flange 5124 bending a predetermined angle outward from the end thereof. As another example, the flange 5124 may be cut to be thinner outward than the thickness of the first conductive ring-shaped side wall 512. According to an embodiment, the first conductive ring-shaped side wall 512 may have a ring-shaped recess 5123 formed on the inner surface 5122. According to an embodiment, the first conductive ring-shaped side wall 512 may have a slit 5125 vertically formed from the upper end thereof to the first surface 5111 of the base structure 511. According to an embodiment, the slit 5125 can provide elastic restoring force that prevents damage and returns the first conductive ring-shaped side wall 512 into the initial state when the second conductive ring-shaped side wall 522 of the connector 520 is inserted into the recess 5101 of the first conductive ring-shaped side wall 512 and the first conductive ring-shaped side wall 512 is slightly opened outward (e.g., the direction in FIG. 6A).

According to various embodiments, the receptacle 510 may have a first connection terminal 5126 extending from the first conductive ring-shaped side wall 512 and protruding through the side 5113 of the base structure 511. According to an embodiment, the receptacle 510 may have a second connection terminal 5131 extending from the conductive pillar structure 513 and protruding from the base structure 511 through the side 5113 of the base structure 511. According to an embodiment, when the receptacle 510 is mounted on the printed circuit board 550, the first connection terminal 5126 and the second connection terminal 5131 may be applied as soldering points. According to an embodiment, the first connection terminal 5126 and the second connection terminal 5131 may be electrically disconnected by the base structure 511 made of an insulating material. According to an embodiment, the first connection terminal 5126 may be electrically connected to a ground plane of the printed circuit board 550. According to an embodiment, the second connection terminal 5131 may be electrically connected to a signal line of the printed circuit board 550. As another example, the first connection terminal 5126 or the second connection terminal 5131 may be exposed through the first surface 5111 and/or the second surface 5112 of the base structure as long as they can be electrically connected to the printed circuit board 550. According to an embodiment, the receptacle 510 may include a plurality of first connection terminals 5126 or second connection terminals 5131.

According to various embodiments, the connector 520 may be installed at an end of the conductive cable 530. According to an embodiment, the connector 520 may have: an upper structure 521 having a third surface 5211 opposite to the receptacle 510 and a fourth surface 5212 facing the receptacle 510; a second conductive ring-shaped side wall 522 protruding from the fourth surface 5212 to be coupled to the first conductive ring-shaped side wall 512 and having a second diameter d2 (e.g., an outer diameter) smaller than the first diameter d1; and a conductive protrusion 523 having a recessed structure 5202 headed and disposed to accommodate at least a portion of the conducive pillar structure 513, and protruding from the fourth surface 5212. According to an embodiment, an end of the second conductive ring-shaped side wall 522 may have a ring-shaped protrusion 5223 protruding toward an outer surface 5221. According to an embodiment, the upper structure 521 and the second conductive ring-shaped side wall 522 may be integrally formed.

According to an embodiment, the second conductive ring-shaped side wall 522 may have the second diameter d2 that can be inserted into the recess 5101 having the first diameter d1 of the first conductive ring-shaped side wall 512 when the connector 520 is coupled to the receptacle 510. According to an embodiment, the second conductive ring-shaped side wall 522 may be formed in a size and a shape such that at least a portion of the outer surface 5221 comes in contact with or comes close to the inner surface 5122 of the first conductive ring-shaped side wall 512 when the connector 520 is coupled to the receptacle 510. According to an embodiment, an end of the second conductive ring-shaped side wall 522 may have a ring-shaped protrusion 5223 protruding toward the outer surface. According to an embodiment, the ring-shaped protrusion 5223 may be formed at a seat to be seated in the ring-shaped recess 5123 formed on the inner surface 5122 of the first conductive ring-shaped side wall 512 when the connector 520 is coupled to the receptacle 510.

According to various embodiments, the connector 520 may have an insulating structure 524 disposed in a space defined by the second conductive ring-shaped side wall 522 and disposed with at least a portion of the upper structure 521 and the second conductive ring-shaped side wall 522. According to an embodiment, the insulating structure 524 may have a predetermined space 5201 at the center. At least a portion of the conductive protrusion 523 may be disposed with the insulating structure 524 in the space 5201 by insert injection. According to an embodiment, at least a portion of the insulating structure 524 may be formed in a shape that is inserted into the recess 5101 formed by the first conductive ring-shaped side wall 512 of the receptacle 510 when the connector 520 is coupled to the receptacle 510. According to an embodiment, the second conductive ring-shaped side wall 522 and the conductive protrusion 523 may be electrically disconnected from each other by the insulating structure 524.

According to various embodiments, the conductive protrusion 523 may be brought in contact with and electrically connected to the conductive pillar structure 513 of the receptacle 510 when the connector 520 is coupled to the receptacle 510. According to an embodiment, the conductive protrusion 523 may have a pair of tension ribs 5231 and 5232 spaced a predetermined distance apart from each other. According to an embodiment, the tension ribs 5231 and 5232 may extend such that the gap gradually decreases as they go to the receptacle 510, and they may have locking protrusions 5233 and 5234 at ends, respectively. According to an embodiment, when the connector 520 is coupled to the receptacle 510, the conductive pillar structure 513 is guided into the recess structure 5202 between the tension ribs 5231 and 5232 and the locking protrusions 5233 and 5234 formed at the ends of the tension ribs 5231 and 5232 may be locked to the locking groove 5132 of the conductive pillar structure 513.

According to various embodiments, the insulating structure 524 is disposed close to or in contact with the inner surface 5222 in the space 5201 defined by the second conductive ring-shaped side wall 522, whereby it is possible to prevent the second conductive ring-shaped side wall 522 from being pushed and deformed inward (e.g., in the direction \textcircled{2} in FIG. 6B) by the first conductive ring-shaped side wall 512 when the connector 520 is coupled to the receptacle 510.

According to an embodiment, the upper structure 521 has an operating portion 5213 extending a predetermined length toward the receptacle 510, so a worker can easily hold the connector 520 when coupling the connector 520 to the receptacle 510.

According to an embodiment, the connector 520 may have an extension 5215 extending a predetermined distance toward the upper structure 521. According to an embodiment, the position of the conductive cable 530 is fixed by the extension 5215 and the conductive cable 530 may be electrically connected with the upper structure 521 and the conductive protrusion 523 of the connector 520.

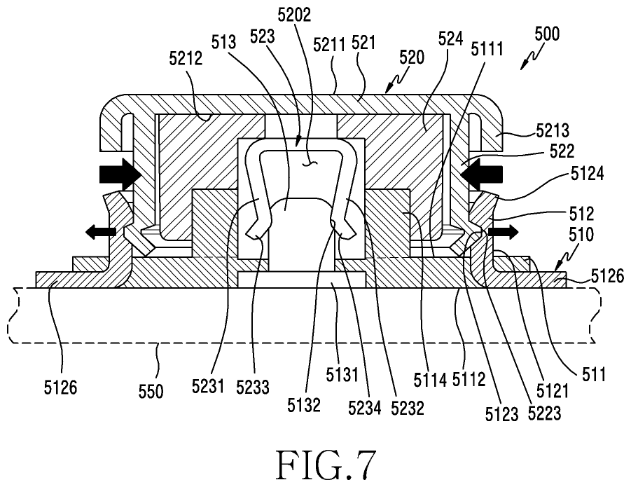

FIG. 7 is a cross-sectional view showing the state in which the receptacle 510 and the connector 520 of FIG. 5 according to various embodiments of the disclosure are combined.

Referring to FIG. 7, the electrical connection device 500 may include a receptacle 510 and a connector 520 coupled to the receptacle 510. According to an embodiment, when the connector 520 is coupled to the receptacle 510, at least a portion of the second conductive ring-shaped side wall 522 of the connector 520 can be inserted into the recess 5101 of the first conductive ring-shaped side wall 512 of the receptacle 510. According to an embodiment, the flange 5124 that opens outward from the first conductive ring-shaped side wall 512 guides the second conductive ring-shaped side wall 522 of the connector 520, thereby being able to prevent mis-insertion. For example, the outer surface 5221 of the second conductive ring-shaped side wall 522 can move in contact with the inner surface 5122 of the first conductive ring-shaped side wall 512, and the ring-shaped protrusion 5223 of the second conductive ring-shaped side wall 522 can be locked to the ring-shaped recess 5123 of the first conductive ring-shaped side wall 512. Further, the conductive pillar structure 513 of the receptacle 510 may be coupled to the conductive protrusion 523 of the connector 520, and the locking protrusions 5233 and 5234 formed at the tension ribs 5231 and 5232 of the conductive protrusion 523 may be locked to the locking groove 5132 of the conductive pillar structure 513. For example, since the ring-shaped protrusion 5223 of the second conductive ring-shaped side wall 522 and the locking protrusions 5233 and 5234 of the conductive protrusion 523 of the connector 520 are locked double to the ring-shaped recess 5123 of the first conductive ring-shaped side wall 512 and the locking groove 5132 of the conductive pillar structure 513 of the receptacle 510, coupling force of the electrical connection device 500 can be improved.

According to various embodiments, when the connector 520 is coupled to the receptacle 510, the insulating structure 524 of the connector 520 is coupled to the protrusion 5114 of the receptacle 510, thereby being able to guide the mounting direction of the connector 520 and prevent the second conductive ring-shaped side wall 522 from being pushed and deformed inward by the inner surface 5122 of the first conductive ring-shaped side wall 512.

According to various embodiments, the first conductive ring-shaped side wall 512 and the conductive pillar structure 513 may be electrically disconnected from each other by the base structure 511. According to an embodiment, the second conductive ring-shaped side wall 522 and the conductive protrusion 523 may be electrically disconnected from each other by the insulating structure 524. According to an embodiment, the second conductive ring-shaped side wall 522 may be electrically connected to the ground plane of the printed circuit board 550 through the first conductive ring-shaped side wall 512 and the first connection terminal 5126 of the receptacle 510. According to an embodiment, the conductive protrusion 523 may be electrically connected to the signal line of the printed circuit board 550 through the conductive pillar structure 513 and the second connection terminal 5131 of the receptacle 510. According to an embodiment, the coaxial cable 530 of the connector 520, the conductive protrusion 523, the conductive pillar structure 513 of the receptacle 510, or the second connection terminal 5131 may be applied as an electrical path for transmitting/receiving a wireless signal to/from a wireless communication circuit mounted on the printed circuit board 550 through an antenna disposed in the electronic device.

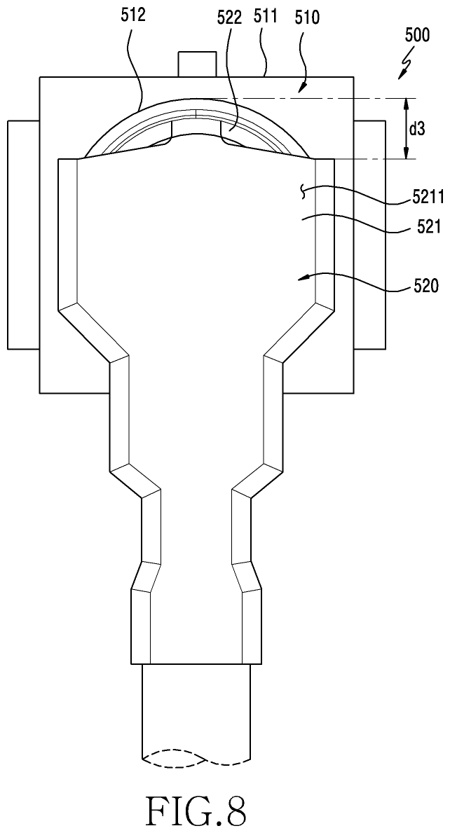

FIG. 8 is a plan view showing the state in which the connector 520 according to various embodiments of the disclosure is electrically connected to the receptacle 510.

Referring to FIG. 8, the electrical connection device 500 may include a receptacle 510 and a connector 520 coupled to the receptacle 510. According to an embodiment, the connector 520 may be disposed such that the second conductive ring-shaped side wall 522 is inserted in a recess (e.g., the recess 5101 shown in FIG. 5) formed by the first conductive ring-shaped side wall 512 of the receptacle 510. In this case, when the connector 520 is seen from above, the upper structure 521 of the connector 520 may be formed such that at least a portion of the second conductive ring-shaped side wall 522 is visually exposed. According to an embodiment, the upper structure 521 may be formed such that at least a portion of the second conductive ring-shaped side wall 522 is exposed by a distance d3 from a point on the first conductive ring-shaped side wall 512 of the receptacle 510 and a point on the upper structure 521. For example, when the connector 520 is coupled to the receptacle 510, a worker can easily couple the connector 520 to the receptacle 510 by the visually exposed second conductive ring-shaped side wall 522 of the connector 520.

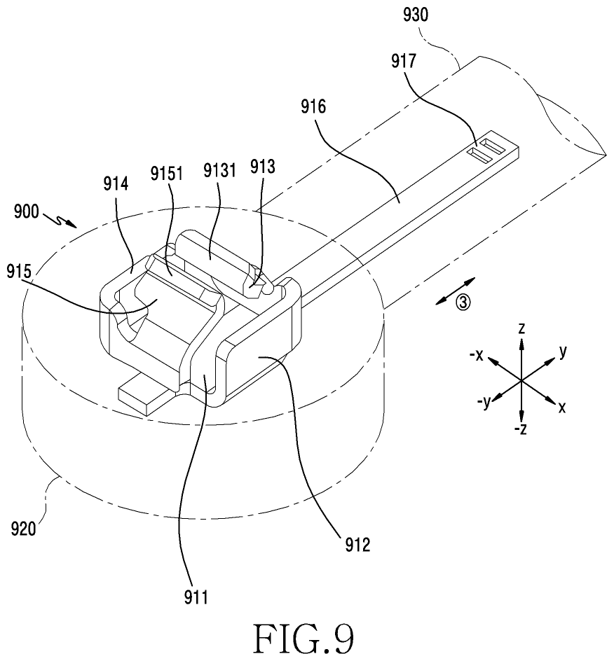

FIG. 9 is a perspective view showing a conductive protrusion 900 according to various embodiments of the disclosure.

The conductive protrusion 900 shown in FIG. 9 may be at least partially similar to the conductive protrusion 523 shown in FIG. 6B or may include other embodiments of conductive protrusions.

Referring to FIG. 9, the conductive protrusion 900 may be formed by bending one metal plate, which is formed in a specific shape by pressing, etc., several times in various directions. According to an embodiment, the conductive protrusion 900 may have a plate portion 911, a first bend 912 bending in a first direction (e.g., a Z-axial direction) from an end of the plate portion 911, a second bend 913 bent in a second direction (e.g., a −Y direction) perpendicular to the first direction from the first bend 912, and a first protrusion 9131 formed at an end of the second bend 913. According to an embodiment, the conductive protrusion 900 may have a third bend 914 bent in the first direction from another end opposite to the end of the plate portion 911, a fourth bend 915 bent in a third direction (e.g., a Y direction) opposite to the second direction from the third bend 914, and a second protrusion 9151 formed at an end of the fourth bend 915. According to an embodiment, the second bend 913 and the fourth bend 915, for example, may correspond to the tension ribs 5231 and 5232 of the conductive protrusion 523 shown in FIG. 6B.

According to an embodiment, the conductive protrusion 900 may have an extension 916, which extends a predetermined distance between the first bend 912 and the third bend 914 of the plate portion 911, and a connecting portion 917 formed at the end thereof. According to an embodiment, the connecting portion 917 may be electrically connected to the conductive cable 930. Though not shown, the conductive protrusion 900 may be fixed by insert injection to an insulating structure (e.g., the insulating structure 524 shown in FIG. 6B) disposed inside a second conductive ring-shaped side wall (e.g., the second conductive ring-shaped side wall 522 shown in FIG. 6B) of the connector 920.

According to various embodiments, the first bend 912 and the fourth bend 915 of the conductive protrusion 900 may be arranged in parallel with each other in a direction (e.g., a direction \textcircled{3}) parallel with the extension 916 to which a conductive cable 930 is connected. Accordingly, the parallel arrangement of the first bend 912 and the fourth bent 915 with the conductive cable 930 can prevent the insulating structure (e.g., the insulating structure 524 shown in FIG. 6B) from being deformed or buckled due to left-right movement of the connector 920 when the connector 920 is coupled to a receptacle (e.g., the receptacle 910 shown in FIG. 6A).

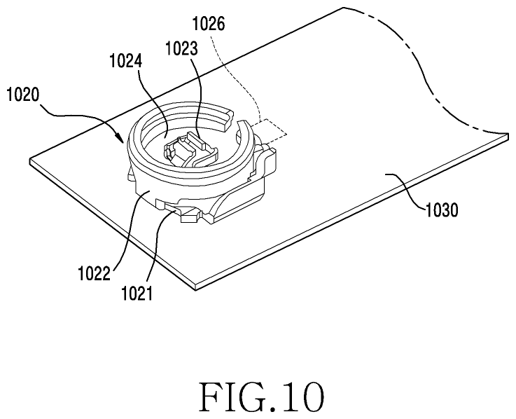

FIG. 10 is a perspective view showing the state in which a connector 1020 is mounted on an FPCB 1030 according to various embodiments of the disclosure.

The connector 1020 shown in FIG. 10 may be at least partially similar to the connector 520 shown in FIG. 5 or may include other embodiments of connectors.

Referring to FIG. 10, the connector 1020 may have an upper structure 1021 (e.g., the upper structure 521 shown in FIG. 5), a second conductive ring-shaped side wall 1022 (e.g., the conductive ring-shaped side wall 522 shown in FIG. 5) formed at the upper structure 1021, an insulating structure 1024 (e.g., the insulating structure 524 shown in FIG. 6B) disposed inside the second conductive ring-shaped side wall 1022, and a conductive protrusion 1023 (e.g., the conductive protrusion 523 shown in FIG. 6B) formed at the insulating structure 1024 at least partially by insert injection. As another example, the conductive protrusion 1023 may be fixed to the insulating structure 1024 disposed inside the second conductive ring-shaped side wall 1022.

According to various embodiments, the connector 1020 may be electrically connected to a Flexible Printed Circuit Board (FPCB) 1030. According to an embodiment, the connector 1020 may be mounted such that the upper structure 1021 is in contact with the FPCB 1030. In this case, at least a portion of the upper structure 1021 may be soldered to a ground plane of the FPCB 1030. According to an embodiment, a connecting portion 1026 of a conductive protrusion 1023 protruding outward from the connector 1020 electrically connected to a signal line of the FPCB 1030 by soldering.

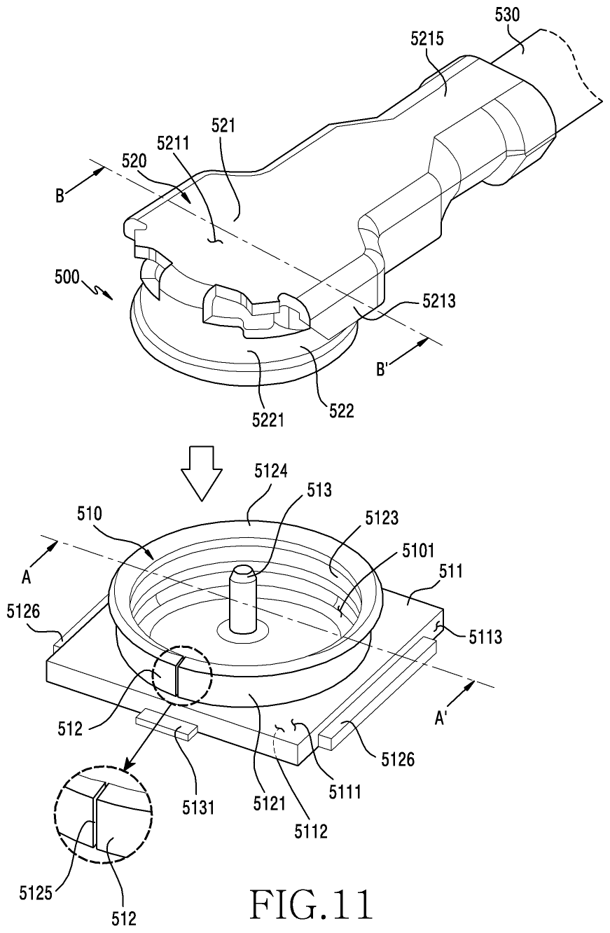

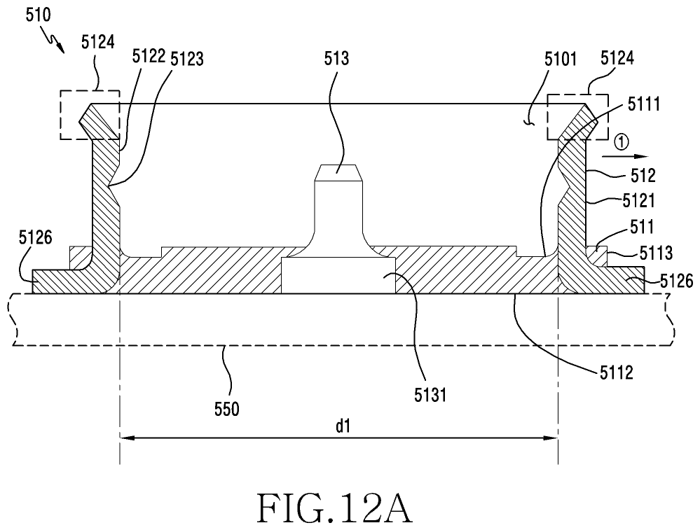

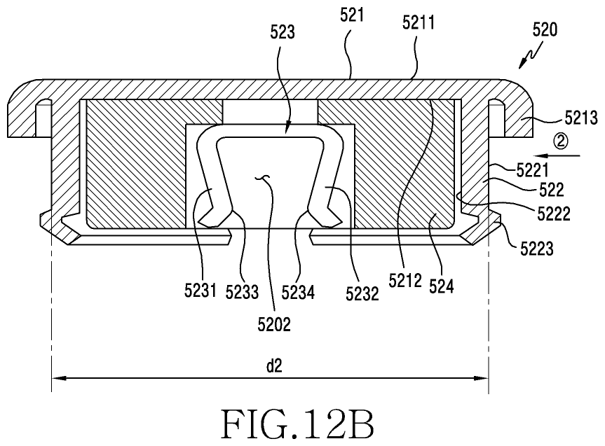

FIG. 11 is an exploded perspective view of the electrical connection device 500 according to various embodiments of the disclosure. FIG. 12A is a cross-sectional view taken along line A-A′ of the receptacle 510 of FIG. 11 according to various embodiments of the disclosure. FIG. 12B is a cross-sectional view taken along line B-B′ of the connector 520 of FIG. 11 according to various embodiments of the disclosure.

The electrical connection device 500 shown in FIG. 11 may be at least partially similar to the electrical connection device 450 shown in FIG. 4 or may include other embodiments of electrical connection devices.

In the description referring to FIGS. 11 to 12B, components of the electrical connection device 500 that are the same as the components of the electrical connection device 500 shown in FIGS. 5 to 6B may not be described.

Referring to FIGS. 11 and 12B, a receptacle 510 may have a base structure 511, a first conductive ring-shaped side wall 512 protruding from a first surface 5111 of the base structure 511 and forming a recess 5101, and a conductive pillar structure 513 protruding from the base structure 511 inside the recess 5101. In this case, the conductive pillar structure 513 may not have a specific locking groove (e.g., the locking groove 5132 shown in FIG. 6A). According to an embodiment, unlike the configuration shown in FIGS. 5 and 6A, the receptacle 510 may not have a protrusion (e.g., the protrusion 5114 shown in FIG. 6A) disposed inside the recess 5101. According to an embodiment, the connector 520 may have a second conductive ring-shaped side wall 522 having a structure that can be seated in the recess 5101 of the first conductive ring-shaped side wall 512 of the receptacle 510. According to an embodiment, the connector 520 may have an insulating structure 524 having a shape corresponding to at least a portion of the recess 5101.

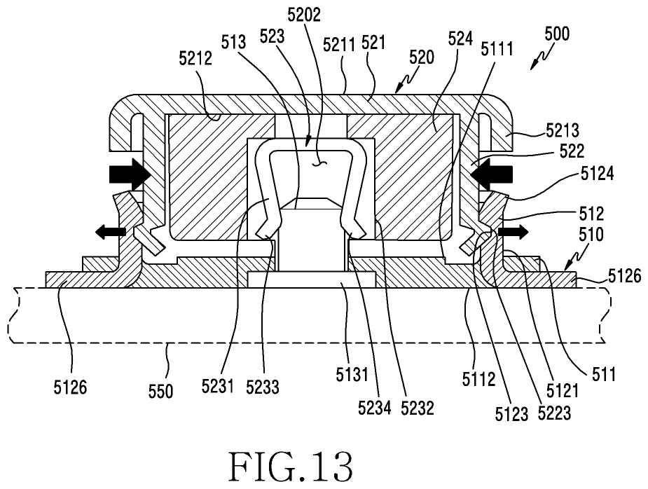

FIG. 13 is a cross-sectional view showing the state in which the receptacle 510 and the connector 520 of FIG. 11 according to various embodiments of the disclosure are combined.

Referring to FIG. 13, the electrical connection device 500 may include a receptacle 510 and a connector 520 coupled to the receptacle 510. According to an embodiment, when the connector 520 is coupled to the receptacle 510, at least a portion of the second conductive ring-shaped side wall 522 of the connector 520 can be inserted into the recess 5101 of the first conductive ring-shaped side wall 512 of the receptacle 510. According to an embodiment, when the connector 520 is coupled to the receptacle 510, the insulating structure 524 of the connector 520 is seated in the recess 5101 of the receptacle 510, thereby being able to guide the mounting direction of the connector 520 and prevent the second conductive ring-shaped side wall 522 from being pushed and deformed toward the conductive protrusion 523 by the inner surface 5122 of the first conductive ring-shaped side wall 512.

According to various embodiments, an electronic device may include: a housing (e.g., the housing 110 shown in FIG. 1); a printed circuit board (e.g., the printed circuit board 550 shown in FIG. 7) disposed in the housing; a receptacle (e.g., the receptacle 510 shown in FIG. 7) mounted on the printed circuit board and having a base structure (e.g., the base structure 511 shown in FIG. 7) that has a first surface (e.g., the first surface 511 shown in FIG. 7) opposite to the printed circuit board and a second surface (e.g., the second surface 5112 shown in FIG. 7) opposite to the first surface and mounted on the printed circuit board, a first conductive ring-shaped side wall (e.g., the first conductive ring-shaped side wall 512 shown in FIG. 7) that protrudes from the first surface of the base structure, forms a recess (e.g., the recess 5101 shown in FIG. 6A) together with the first surface, and has a first diameter (e.g., the first diameter d1 shown in FIG. 6A), and a conductive pillar structure (e.g., the conductive pillar structure 513 shown in FIG. 7) that protrudes from the first surface, is at least partially disposed in the recess, and is laterally surrounded by the first conductive ring-shaped side wall; a connector (e.g., the connector 510 shown in FIG. 7) separably coupled to the receptacle and having an upper structure (the upper structure 521 shown in FIG. 7) that has a third surface (e.g., 5211 in FIG. 7) opposite to the receptacle and a fourth surface (5212 in FIG. 7) facing the receptacle, a second conductive ring-shaped side wall (e.g., the second conductive ring-shaped side wall shown in FIG. 7) that is configured to be coupled to the first conductive ring-shaped side wall, protrudes from the fourth surface, and has a second diameter (e.g., the second diameter d2 shown in FIG. 6B) smaller than the first diameter, and a conductive protrusion (e.g., the conductive protrusion 523 shown in FIG. 7) that forms a recess structure (e.g., the recess structure 5202 shown in FIG. 6B) headed and disposed to accommodate at least a portion of the conductive pillar structure and protrudes from the fourth surface; and a cable being as a coaxial cable (e.g., the coaxial cable 530 shown in FIG. 5) that has an end connected to the connector, and having a first conductive path connected to the conductive protrusion and a second conductive path connected to the second conductive ring-shaped side wall.

According to various embodiments, the second conductive ring-shaped side wall has an outer surface (e.g., the outer surface 5221 shown in FIG. 6B) and a ring-shaped protrusion (e.g., the ring-shaped protrusion 5223 shown in FIG. 6B) formed on the outer surface, the first conductive ring-shaped side wall has an inner surface (e.g., the inner surface 5122 shown in FIG. 6A) and a ring-shaped recess (e.g., the ring-shaped recess 5123 shown in FIG. 6A), and the ring-shaped protrusion may be coupled to the ring-shaped recess.

According to various embodiments, when the upper structure is seen from above, a portion of the first conductive ring-shaped side wall may not overlap the upper structure.

According to various embodiments, the electronic device may include a wireless communication circuit mounted on a printed circuit board and electrically connected to the receptacle, and an antenna electrically connected to the coaxial cable.

According to various embodiments, the connector may have a ring-shaped insulating structure (e.g., the insulating structure 524 shown in FIG. 6B) disposed between the second conductive ring-shaped side wall and the conductive protrusion.

According to various embodiments, the first conductive ring-shaped side wall may have a slit (e.g., the slit 5125 shown in FIG. 5) vertically formed to the first surface.

According to various embodiments, at least a portion of the first conductive ring-shaped side wall may protrude through the base structure and may be electrically connected to the printed circuit board.

According to various embodiments, at least a portion of the conductive pillar structure may protrude through the base structure and may be electrically connected to the printed circuit board.

According to various embodiments, an end of the first conductive ring-shaped side wall may further have a flange (e.g., the flange 5124 shown in FIG. 6A) bending outward at a predetermined angle to guide the second conductive ring-shaped side wall.

According to various embodiments, the electronic device may have an extension (e.g., the extension 5125 shown in FIG. 5) extending from the upper structure, and the upper structure and/or the extension may be electrically connected with the coaxial cable.

According to various embodiments, the conductive protrusion may have a plate (e.g., the plate 911 shown in FIG. 9), a pair of tension ribs (e.g., the tension ribs 913 and 915 shown in FIG. 9) spaced a predetermined distance from each other at positions facing each other from the plate, and extending outward, and an extension (the extension 916 shown in FIG. 9) extending from the plate between the tension ribs and having a connecting portion at an end; and the conductive pillar structure may be physically in contact by being inserted in the recess structure between the tension ribs.

According to various embodiments, at least one of the tension ribs may have a locking protrusion (e.g., the locking protrusions 9131 and 9151 shown in FIG. 9) protruding toward the recess structure.

According to various embodiments, the conductive pillar structure may have a locking groove (e.g., the locking groove 5132 shown in FIG. 6A) formed on an outer surface, and the locking protrusion may be configured to be locked to the locking groove when the conductive pillar structure is inserted into the recess structure.

According to various embodiments, the tension ribs may be arranged in parallel with each other in a direction parallel with the extension.

According to various embodiments, the first conductive ring-shaped side wall and the conductive pillar structure may be disposed to be electrically disconnected by the base structure.

According to various embodiments, the second conductive ring-shaped side wall and the conductive protrusion may be disposed to be electrically disconnected by the insulating structure.

According to various embodiments, a receptacle (e.g., the receptacle 510 shown in FIG. 7) that is coupled to a connector (e.g., the connector 520 shown in FIG. 7) includes: a base structure (e.g., the base structure 511 shown in FIG. 7) having a first surface (e.g., the first surface 5111 show in FIG. 7) and a second surface (e.g., the second surface 5112 shown in FIG. 7) opposite to the first surface and mounted on a printed circuit board (e.g., the printed circuit board 550 shown in FIG. 7); a first conductive ring-shaped side wall (e.g., the first conductive ring-shaped side wall shown in FIG. 7) protruding from the first surface of the base structure, forming a recess (e.g., the recess 5101 shown in FIG. 6A) together with the first surface, and having a first diameter (e.g., the first diameter d1 shown in FIG. 6A); and a conductive pillar structure (e.g., the conductive pillar structure shown in FIG. 7) protruding from the first surface, at least partially disposed in the recess, and laterally surrounded by the first conductive ring-shaped side wall, in which the first diameter of the first conductive ring-shaped side wall may have a size allowing a second conductive ring-shaped side wall (e.g., the second conductive ring-shaped side wall 522 shown in FIG. 7) of the connector to be accommodated in the recess.

According to various embodiments, the first conductive ring-shaped side wall may have a ring-shaped recess formed on an inner surface, and the ring-shaped recess may accommodate a ring-shaped protrusion formed on an outer surface of the second conductive ring-shaped side wall when the connector is accommodated in the recess of the receptacle.

According to various embodiments, a connector (e.g., the connector 520 shown in FIG. 7 that is coupled to a receptacle (e.g., the receptacle 510 shown in FIG. 7) includes: an upper structure (e.g., the upper structure shown in FIG. 7) having a first surface (e.g., the third surface 5211 shown in FIG. 7) opposite to the receptacle and a second surface (e.g., the fourth surface 5212 shown in FIG. 7) facing the receptacle; a first conductive ring-shaped side wall (e.g., the second conductive ring-shaped side wall 522 shown in FIG. 7) protruding from the second surface and having a first diameter d1 (e.g., the second diameter d2 shown in FIG. 6B) to be coupled to a second conductive ring-shaped side wall (e.g., the first conductive ring-shaped side wall 512 shown in FIG. 7) of the receptacle; and a conductive protrusion (e.g., the conductive protrusion 523 shown in FIG. 7) at least partially disposed in a space defined by the first conductive ring-shaped side wall, and protruding from the second surface, in which the first diameter of the first conductive ring-shaped side wall may have a size allowing the second conductive ring-shaped side wall to be accommodated in a recess (e.g., the recess 5101 shown in FIG. 6A) formed by the second conductive ring-shaped side wall of the receptacle.

According to various embodiments, the first conductive ring-shaped side wall may have a ring-shaped protrusion formed on an outer surface, and the ring-shaped protrusion may be accommodated in a ring-shaped recess formed on an inner surface of the second conductive ring-shaped side wall when the connector is accommodated in the receptacle.

Further, the embodiments described and shown in the specification and the drawings are specific examples for easily explaining the disclosure and helping understand an embodiment the disclosure and do not limit the scope of the disclosure. Therefore, other than the embodiments described herein, all of changes or modifications based on the spirit of the disclosure should be construed as being included in the scope of the disclosure.

1. An electronic device comprising:
a housing:
a printed circuit board disposed in the housing;
a receptacle mounted on the printed circuit board, the receptacle having a base structure that has a first surface opposite to the printed circuit board and a second surface opposite to the first surface and mounted on the printed circuit board, a first conductive ring-shaped side wall that protrudes from the first surface of the base structure, forms a recess together with the first surface, and has a first diameter, and a conductive pillar structure that protrudes from the first surface, is at least partially disposed in the recess, and is laterally surrounded by the first conductive ring-shaped side wall;
a connector separably coupled to the receptacle, the connector having an upper structure that has a third surface opposite to the receptacle and a fourth surface facing the receptacle, a second conductive ring-shaped side wall that is configured to be coupled to the first conductive ring-shaped side wall, protrudes from the fourth surface, and has a second diameter smaller than the first diameter, and a conductive protrusion that forms a recess structure headed and disposed to accommodate at least a portion of the conductive pillar structure and protrudes from the fourth surface; and
a cable being as a coaxial cable that has an end connected to the connector, the cable having a first conductive path connected to the conductive protrusion and a second conductive path connected to the second conductive ring-shaped side wall.

2. The electronic device of claim 1, wherein the second conductive ring-shaped side wall has an outer surface and a ring-shaped protrusion formed on the outer surface,
the first conductive ring-shaped side wall has an inner surface and a ring-shaped recess, and
the ring-shaped protrusion is coupled to the ring-shaped recess.

3. The electronic device of claim 1, wherein when the upper structure is seen from above, a portion of the first conductive ring-shaped side wall does not overlap the upper structure.

4. The electronic device of claim 1, comprising:
a wireless communication circuit mounted on the printed circuit board and electrically connected to the receptacle; and
an antenna electrically connected to the coaxial cable.

5. The electronic device of claim 1, wherein the connector includes a ring-shaped insulating structure disposed between the second conductive ring-shaped side wall and the conductive protrusion.

6. The electronic device of claim 1, wherein the first conductive ring-shaped side wall has a slit vertically formed to the first surface.

7. The electronic device of claim 1, wherein at least a portion of the first conductive ring-shaped side wall protrudes through the base structure and is electrically connected to the printed circuit board.

8. The electronic device of claim 1, wherein at least a portion of the conductive pillar structure protrudes through the base structure and is electrically connected to the printed circuit board.

9. The electronic device of claim 1, wherein an end of the first conductive ring-shaped side wall further has a flange bending outward at a predetermined angle to guide the second conductive ring-shaped side wall.

10. The electronic device of claim 1, wherein the conductive protrusion has a plate, a pair of tension ribs spaced a predetermined distance from each other at positions facing each other from the plate, and extending outward, and an extension extending from the plate between the tension ribs and having a connecting portion at an end; and
the conductive pillar structure is physically in contact by being inserted in the recess structure between the tension ribs.

11. The electronic device of claim 10, wherein at least one of the tension ribs has a locking protrusion protruding toward the recess structure.

12. The electronic device of claim 11, wherein the conductive pillar structure has a locking groove formed on an outer surface, and
the locking protrusion is configured to be locked to the locking groove when the conductive pillar structure is inserted into the recess structure.

13. The electronic device of claim 10, wherein the tension ribs are arranged in parallel with each other in a direction parallel with the extension.

14. A receptacle that is coupled to a connector, the receptacle comprising:
a base structure having a first surface and a second surface opposite to the first surface and mounted on a printed circuit board;
a first conductive ring-shaped side wall protruding from the first surface of the base structure, forming a recess together with the first surface, and having a first diameter; and
a conductive pillar structure protruding from the first surface, at least partially disposed in the recess, and laterally surrounded by the first conductive ring-shaped side wall,
wherein the first diameter of the first conductive ring-shaped side wall has a size allowing a second conductive ring-shaped side wall of the connector to be accommodated in the recess.

15. The receptacle of claim 14, wherein the first conductive ring-shaped side wall has a ring-shaped recess formed on an inner surface, and
the ring-shaped recess accommodates a ring-shaped protrusion formed on an outer surface of the second conductive ring-shaped side wall when the connector is accommodated in the recess of the receptacle.

16. The electronic device of claim 1, further comprises an extension extending from the upper structure, and
wherein at least one of the upper structure and the extension is electrically connected with the coaxial cable.

17. The electronic device of claim 1, wherein the first conductive ring-shaped side wall and the conductive pillar structure are disposed to be electrically disconnected by the base structure.

18. The electronic device of claim 1, wherein the second conductive ring-shaped side wall and the conductive protrusion are disposed to be electrically disconnected by an insulating structure.

19. A connector that is coupled to a receptacle, the connector comprising:
an upper structure having a first surface opposite to the receptacle and a second surface facing the receptacle,
a first conductive ring-shaped side wall protruding from the second surface to be coupled to a second conductive ring-shaped side wall of the receptacle, and having a first diameter, and
a conductive protrusion at least partially disposed in a space defined by the first conductive ring-shaped side wall, and protruding from the second surface,
wherein the first diameter of the first conductive ring-shaped side wall has a size allowing the second conductive ring-shaped side wall to be accommodated in a recess formed by the second conductive ring-shaped side wall of the receptacle.

20. The connector of claim 19, wherein the first conductive ring-shaped side wall has a ring-shaped protrusion formed on an outer surface, and
the ring-shaped protrusion is accommodated in a ring-shaped recess formed on an inner surface of the second conductive ring-shaped side wall when the connector is accommodated in the receptacle.
